(19) United States
(12) Patent Application Publication
(10) Pub. No.: US 2026/0037343 A1
(43) Pub. Date: Feb. 5, 2026

(54) NON-TRANSITORY RECORDING MEDIUM, INFORMATION PROCESSING APPARATUS, AND INFORMATION PROCESSING METHOD

(71) Applicant: PFU Limited, ISHIKAWA (JP)

(72) Inventors: Daiki KAWAI, ISHIKAWA (JP); Tomoaki WADA, ISHIKAWA (JP)

(21) Appl. No.: 19/265,171

(22) Filed: Jul. 10, 2025

(30) Foreign Application Priority Data
Jul. 31, 2024 (JP) 2024-124767

(51) Int. Cl. G06F 9/54; G06F 3/04842; G06F 3/0486

(52) U.S. Cl. CPC G06F 9/543; G06F 3/04842; G06F 3/0486; G06F 2209/545

(57) ABSTRACT

A computer-readable, non-transitory medium stores a computer program. The computer program causes an information processing apparatus including circuitry to execute a process. The process includes acquiring data derived from image data, from an external apparatus external to the information processing apparatus, displaying a display component representing the data on a display; and receiving an operation of moving the display component to a screen to transfer the data to an application. The screen is displayed on the display by the application installed on the information processing apparatus.

### CROSS-REFERENCE TO RELATED APPLICATIONS

This patent application is based on and claims priority pursuant to 35 U.S.C. § 119 (a) to Japanese Patent Application No. 2024-124767, filed on Jul. 31, 2024, in the Japan Patent Office, the entire disclosure of which is hereby incorporated by reference herein.

### BACKGROUND

The present disclosure relates to a non-transitory recording medium, an information processing apparatus, and an information processing method.

A scanner application (app) for controlling a scanner is known. A scanner app installed on an information processing apparatus acquires data derived from image data from a scanner. The data can be used by a user in various application software (referred to simply as an application or an app in the following description). For example, after the scanner app acquires the data derived from image data, the data may be shared among sites by using a teleconference application or may be managed by using a digital notebook application.

A technique for sharing various types of data among a plurality of applications is known. A technique for extracting a supporting application supporting an execution property of a scan process from a plurality of applications, displaying identification information for identifying the supporting application on a display, and sharing image information via an application programming interface (API) with an output destination application that is selected has been known.

### SUMMARY

The computer-readable, non-transitory medium according to one aspect of the present disclosure stores a computer program. The computer program causes an information processing apparatus including circuitry to execute a process. The process includes acquiring data derived from image data, from an external apparatus external to the information processing apparatus, displaying a display component representing the data on a display; and receiving an operation of moving the display component to a screen to transfer the data to an application. The screen is displayed on the display by the application installed on the information processing apparatus.

The information processing apparatus according to another aspect of the present disclosure includes circuitry to acquire data derived from image data, from an external apparatus external to the information processing apparatus, display a display component representing the data on a display, and receive an operation of moving the display component to a screen to transfer the data to an application. The screen is displayed on the display by the application installed on the information processing apparatus.

The information processing method according to still another aspect of the present disclosure includes acquiring data derived from image data, from an external apparatus external to the information processing apparatus, displaying a display component representing the data on a display, and receiving an operation of moving the display component to a screen to transfer the data to an application. The screen is displayed on the display by the application installed on the information processing apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram for explaining processing or an operation performed by an information processing apparatus and an operation performed by a user;

FIG. 2 is a diagram illustrating an overall configuration of a scanner system;

FIG. 3 is a block diagram illustrating a hardware configuration of an information processing apparatus;

FIG. 4 is a block diagram illustrating functions of a scanner and an information processing apparatus;

FIG. 5 is a diagram illustrating an example of a scan settings screen;

FIG. 6 is a diagram illustrating an example of an integration assistance screen;

FIG. 7 is a sequence diagram illustrating a process in which a document is scanned by the scanner system of FIG. 2 and an integration assistance screen is displayed on the information processing apparatus of FIG. 3;

FIG. 8 is a flowchart of a process performed by the information processing apparatus of FIG. 3 for displaying an integration assistance screen and transferring image data to a target app according to a data transfer operation;

FIG. 9 is a diagram illustrating an example of an integration assistance screen and a screen of a target app that are displayed on the information processing apparatus of FIG. 3;

FIG. 10 is a diagram illustrating another example of a screen displayed on the information processing apparatus of FIG. 3 while a drag-and-drop operation is being performed on the screen;

FIG. 11 is a diagram illustrating still another example of a screen displayed on the information processing apparatus of FIG. 3 when a drag-and-drop operation is completed;

FIG. 12 is a diagram illustrating an example of an integration destination selection screen displayed by a scanner app;

FIG. 13 is a flowchart of a process performed by the information processing apparatus of FIG. 3 for displaying an integration assistance screen after displaying a preview and transferring image data to a target app according to a data transfer operation;

FIG. 14 is a diagram illustrating a screen transition in displaying an integration assistance screen on the information processing apparatus of FIG. 3;

FIG. 15 is a block diagram illustrating functions of a scanner and an information processing apparatus;

FIG. 16 is a flowchart of a process performed by the information processing apparatus of FIG. 3 for displaying an integration assistance screen and transferring image data to a target app according to a data transfer operation;

FIG. 17 is a flowchart of a process performed by the information processing apparatus of FIG. 3 for displaying an integration assistance screen and transferring image data to a target app according to a data transfer operation;

FIGS. 18A and 18B are diagrams each illustrating a display position of a screen of a target app;

FIGS. 19A and 19B are diagrams each illustrating a display position of a screen of a target app; and

FIG. 20 is a flowchart of a process for adjusting a display position of an integration assistance screen performed by a screen control unit. The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing apparatus and an information processing method performed by the information processing apparatus according to embodiments of the present disclosure are described below with reference to the drawings.

### Overview of Processes or Operation

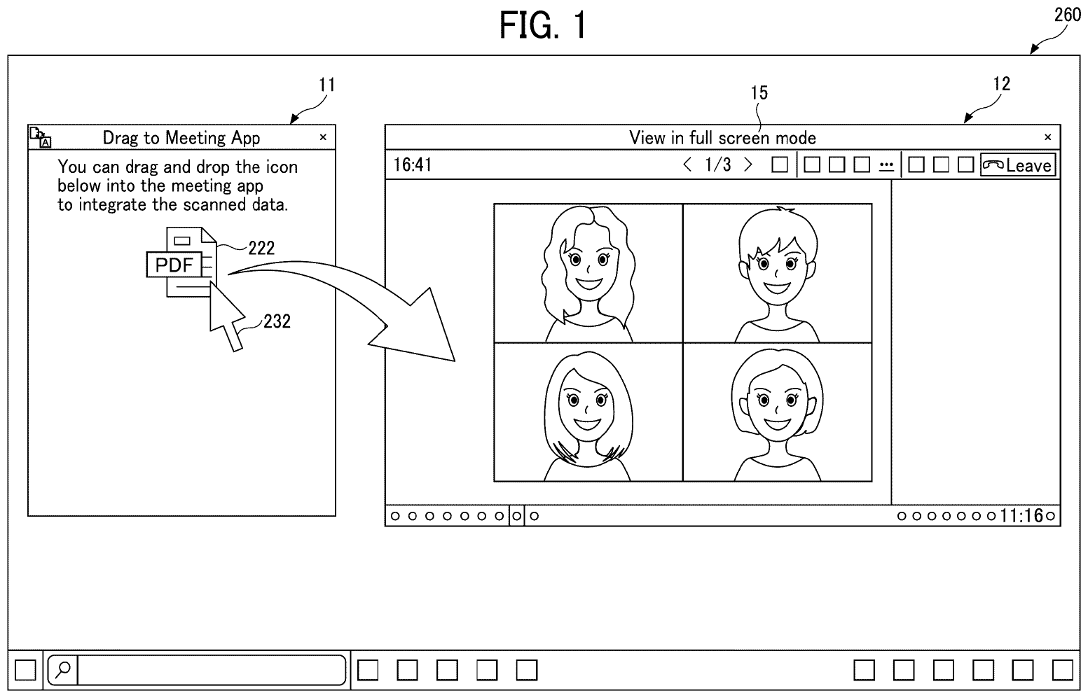

FIG. 1 is a diagram for explaining processing or an operation performed by an information processing apparatus and an operation performed by a user, according to an embodiment. An information processing apparatus 3 is communicably connected to a scanner 4, and a scanner application (scanner app) 13 for controlling the scanner 4 is installed on the information processing apparatus 3. The details of each of the information processing apparatus 3, the scanner 4, and the scanner app 13 are described later. Further, an application in which data derived from image data generated by the scanner app 13 is to be used is installed on the information processing apparatus 3. In the following description, the data derived from image data may be referred to simply as “image data,” and the application in which the data derived from image data is to be used may be referred to as “target app.”

When the scanner app 13 causes the scanner 4 to read a document, the scanner app 13 acquires a file including image data from the scanner 4. The scanner app 13 stores the file in a temporary folder and automatically displays an integration assistance screen 11. The integration assistance screen 11 includes a file icon 222 representing the file stored in the temporary folder. The user drags and drops the file icon 222 displayed on the integration assistance screen 11 onto a screen 15 of a target app 12 to transfer the image data to the target app 12.

Accordingly, the user can use the image data in the target app 12. How the user uses the image data in the target app 12 varies depending on the target app 12. For example, when the target app 12 is an application that holds a video conference, the image data can be shared among different sites.

As described above, the scanner app 13 of the present embodiment automatically displays the integration assistance screen 11 including the file icon 222 by executing scan, and thus the user does not need to assign a folder to the scanner app 13 or open the folder. The user may drag the displayed file icon 222 onto the screen 15 of the target app 12 to transfer the file to the target app 12. Accordingly, the scanner app 13 can reduce operational mistakes such as file mix-ups, incorrect file transmission, or accidental deletion of a file. Further, this facilitates the resolution of issues such as difficulties in integrating data between applications.

### Terms

The data transfer operation is an operation for transferring image data to the target app 12. The data transfer operation is carried out by dragging and dropping, copying and pasting, or cutting and pasting of files. The data transfer operation may be carried out by another action that can transfer image data to the target app 12. Dragging and dropping, copying and pasting, or cutting and pasting may be referred to as “data transfer operation.” Further, dragging and dropping, copying and pasting, and cutting and pasting may be referred to as a drag-and-drop operation, a copy-and-paste operation, and a cut-and-paste operation, respectively. Further, when the user operates a touch panel instead of a mouse, an operation corresponding to dragging and dropping, copying and pasting, or cutting and pasting on the touch panel is “data transfer operation.”

The external apparatus is an apparatus (device) that generates image data, and includes the scanner 4, a smartphone, a digital camera, or other types of devices.

“Data derived from image data” may be regarded as data based on image data and include the image data itself, files including the image data, text data obtained from character recognition, and any files that include such text data.

The display component is a component of a graphical user interface (GUI). The display component includes an icon, a picture, a figure, an image, a character, or other content.

### First Embodiment

### System Configuration

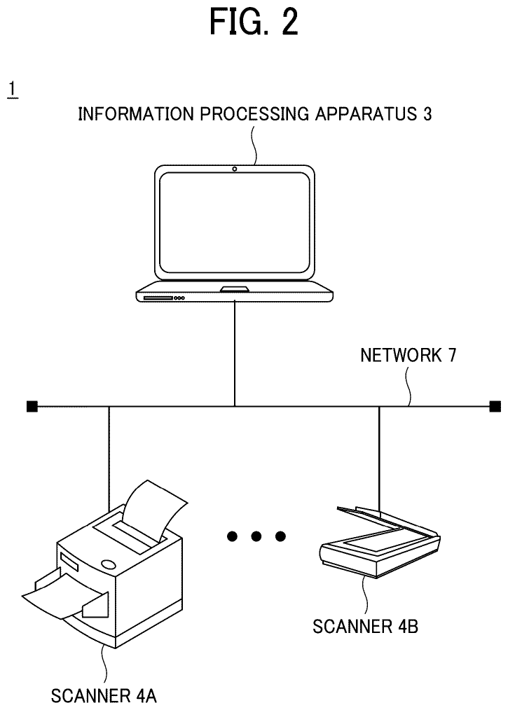

Referring to FIG. 2, an overall configuration of a scanner system 1 is described below. FIG. 2 is a diagram illustrating an overall configuration of the scanner system 1. As illustrated in FIG. 2, the scanner system 1 includes the information processing apparatus 3, and scanners 4A and 4B. The information processing apparatus 3, the scanner 4A, and the scanner 4B are communicably connected to each other via a network 7. In the present embodiment, either of the scanner 4A and the scanner 4B, or both, may be referred to as “scanner 4.”

The network 7 may be, for example, the user's home local area network (LAN) or an internal LAN. The network 7 may include wireless communication, such as WI-FI. The network 7 may include a wide area network (WAN), a virtual private network (VPN), or a wide area ETHERNET (registered trademark).

The information processing apparatus 3 may be directly connected to the scanner 4 via a universal serial bus (USB) cable in a one-to-one wired connection. The information processing apparatus 3 and the scanner 4 may also communicate wirelessly in a one-to-one connection. WI-FI Direct and BLUETOOTH (registered trademark) are known as such communication methods.

The information processing apparatus 3 may be a general-purpose information processing apparatus. A scanner app for controlling the scanner 4 is installed on the information processing apparatus 3. Further, various target apps 12 are installed on the information processing apparatus 3. Some of the target apps 12 have integration functionality with the scanner app via an application programming interface (API) or similar mechanism, while the others do not. The scanner app calls an API to transfer image data to a target app that has integration functionality. The scanner app assists the user in transferring data to the target apps 12 that do not have integration functionality. The target app 12 is assumed to support data transfer by a data transfer operation.

The scanner app may have a function of performing character recognition on image data of a document included in a file received from the scanner 4. The information processing apparatus 3 may transmit the image data to a server via the network 7.

Specifically, the information processing apparatus 3 may be an apparatus or a device having a communication function, such as a personal computer (PC), a smartphone, or a tablet PC. Further, the information processing apparatus 3 may be any apparatus or device that can run the scanner app and the target app.

The scanner 4 is an optical reading device, and transmits image data generated by reading a document to the information processing apparatus 3. In the present embodiment, the scanner 4 scans various documents that are examples of input documents.

The scanner 4 may be a device called a multifunction peripheral (MFP) or a multifunction machine. That is, the scanner 4 may have a printer function, a copy function, a facsimile function, or similar functions in addition to the scanner function.

In FIG. 2, the scanner 4 and the information processing apparatus 3 are separate from each other, but the scanner 4 and the information processing apparatus 3 may be integrated into a single device (e.g., an MFP).

The scanner 4 may be a smartphone or a digital camera. A file including image data captured by a smartphone or a digital camera may be transmitted via the network 7 or may be stored in a removable recording medium (removable storage medium). When such a recording medium is mounted on the information processing apparatus 3, the information processing apparatus 3 can acquire the file.

### Hardware Configuration

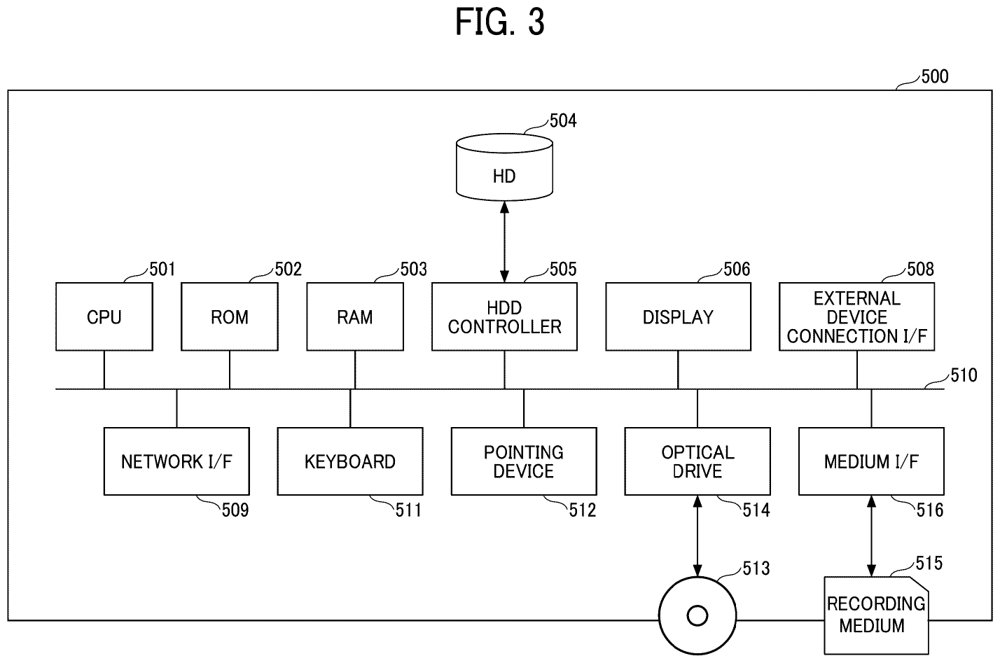

A hardware configuration of the information processing apparatus 3 according to the present embodiment is described below with reference to FIG. 3. FIG. 3 is a diagram illustrating a hardware configuration of the information processing apparatus 3 according to the present embodiment. As illustrated in FIG. 3, the information processing apparatus 3 is implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls the entire operation of the computer 500. The ROM 502 stores a program such as an initial program loader (IPL) used for booting the CPU 501. The RAM 503 is used as a work area for the CPU 501. The HD 504 stores various data such as a program. The HDD controller 505 controls the reading or writing of various data from or to the HD 504 under the control of the CPU 501. The display 506 displays various information such as a cursor, a menu, a window, text, and an image. The external device connection I/F 508 is an interface for connecting to various external devices. Examples of the external device include, but are not limited to, a USB memory and a printer. The network I/F 509 is an interface for data communication through the network 7. The bus line 510 is, for example, an address bus or a data bus that electrically connects the components illustrated in FIG. 3 such as the CPU 501 with one another.

The keyboard 511 is an example of an input device provided with a plurality of keys used for inputting, for example, characters, numerical values, and various instructions. The pointing device 512 is an example of an input device that allows the user to select or execute a specific instruction, select a target for processing, or move a cursor being displayed. The optical drive 514 controls the reading or writing of various data from or to an optical recording medium 513 that is an example of a removable recording medium. The optical recording medium 513 is, for example, a compact disc (CD), a digital versatile disk (DVD), or a BLU-RAY (registered trademark). The medium I/F 516 controls the reading or writing (storing) of data from and to a recording medium 515 such as a flash memory.

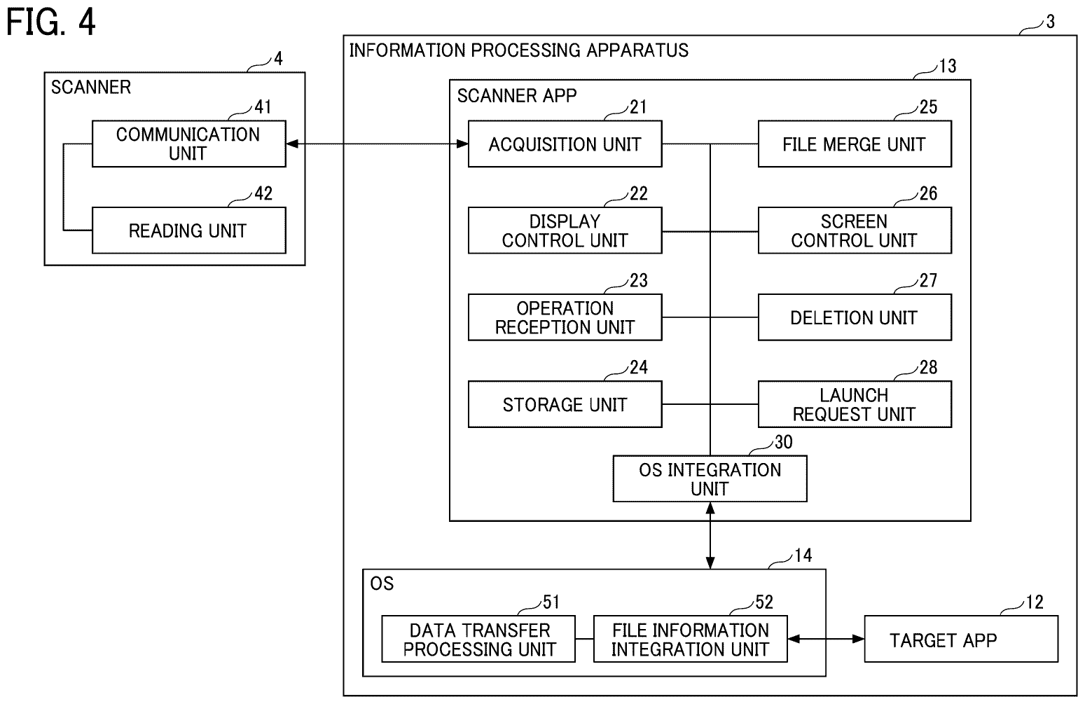

A functional configuration of the information processing apparatus 3 is described in detail below with reference to FIG. 4. FIG. 4 is a block diagram illustrating functions of the scanner 4 and the information processing apparatus 3.

### Scanner

The scanner 4 includes a communication unit 41 and a reading unit 42. The reading unit 42 feeds document sheets one by one by an automatic document feeder (ADF) function and scans the surface of each document sheet using a line sensor to generate image data having a predetermined resolution and gradation. The ADF function may be omitted, and the scanner 4 may read the surface of the document sheet placed on the transparent glass by the user.

The reading unit 42 generates a file in a predetermined format. The file includes image data. The predetermined format may be, for example, Portable Document Format (PDF) or Joint Photographic Experts Group (JPEG). Further, the file format may be any format, such as Portable Network Graphics (PNG), Tagged Image File Format (TIFF), or HyperText Markup Language (HTML). The predetermined format may be a format unique to the scanner 4 and the scanner app 13. When the document has multiple pages, the reading unit 42 generates one file for one page of the document in the default settings. When the default settings are modified to set aggregated reading, the multiple pages are included in one file. These settings are referred to as “setting to split output into multiple files.” In contrast, when “setting to merge files” is enabled, multiple files each including one or more pages are merged into one file. The reading unit 42 or the scanner app 13 may merge the multiple pages into one file.

In the present embodiment, for convenience of explanation, the reading unit 42 generates a file. However, the scanner app 13 may convert image data into a file. For example, the scanner 4 may transmit image data that is not in a file format to the information processing apparatus 3, and the scanner app 13 may convert the image data into a file.

The communication unit 41 communicates with the information processing apparatus 3 using a communication protocol such as a simple network management protocol (SNMP) or communicates with the information processing apparatus 3 using a dedicated line such as a USB cable. The communication unit 41 transmits the file generated by the reading unit 42 to the information processing apparatus 3.

### Information Processing Apparatus

The information processing device 3 includes an acquisition unit 21, a display control unit 22, an operation reception unit 23, a storage unit 24, a file merge unit 25, a screen control unit 26, a deletion unit 27, a launch request unit 28, and an operating system (OS) integration unit 30. Each of the functional units of the information processing apparatus 3 is implemented by the CPU 501 of the information processing apparatus 3 executing instructions of a program. The program may be, for example, the scanner app 13 dedicated to the scanner 4 or the scanner app 13 that is a general-purpose scanner app. The scanner app 13 may be a web application. The web application refers to software or a mechanism that is executed in the browser and operates by coordinating a program in a programming language (for example, JAVASCRIPT (registered trademark)) running in the web browser with a program on the web server. In the present embodiment, a native application refers to a program that is installed on the information processing apparatus 3 and can communicate with the scanner 4.

The acquisition unit 21 acquires a file from the scanner 4 by communicating with the scanner 4 via, for example, the network 7 or a USB cable. The acquisition unit 21 can also transmit a control signal indicating, for example, a reading condition and a reading start to the scanner 4. A tool without an interesting name (TWAIN) driver may be installed on the information processing apparatus 3, or a unique driver may be installed on the information processing apparatus 3. The TWAIN is a standard that defines technical specifications for controlling an input device such as an image scanner from a scanner app running on a computer to capture image data.

The display control unit 22 controls a screen of the scanner app 13. The display control unit 22 displays a settings screen according to a user operation, and displays image data included in a file transmitted from the scanner 4.

The operation reception unit 23 receives an operation on the scanner app 13. The operation reception unit 23 receives a “data transfer operation” for transferring image data to the target app 12, as one of the operations. The data transfer operation is carried out by dragging and dropping, copying and pasting, or cutting and pasting. The data transfer operation may be carried out by another action that can transfer image data to the target app 12. The data transfer operation is an operation that involves not only the functionality of the scanner app 13 but also the functionality of an OS. This is because it is difficult for the scanner app 13 to control the target app 12 that is a data transfer destination.

Some of the target apps 12 do not have integration functionality using, for example, an API. When the target app 12 has the integration functionality, the user can also perform a data transfer operation on the target app 12.

The storage unit 24 stores a file acquired by the acquisition unit 21 in a predetermined temporary folder (an example of a storage area). When the acquisition unit 21 receives the completion of the scanning of all pages, the acquisition unit 21 may store the multiple files in the temporary folder. Alternatively, the acquisition unit 21 may store one or more files in the temporary folder each time the acquisition unit 21 acquires a file.

When the document includes multiple pages, either “setting to merge files” or “setting to split output into multiple files” is settable in the scanner app 13 according to a user operation before scanning. When “setting to split output into multiple files” is enabled, the number of data transfer operations required corresponds to the number of files. When receiving a notification indicating that the scanning of all pages is completed from the scanner 4, the file merge unit 25 merges the multiple files into one file. In other words, the file merge unit 25 merges a plurality of data pieces into a data set. The multiple files each generated for a corresponding page are separately stored. The file merge unit 25 may further compress the merged file into, for example, a ZIP file. The scanner app 13 can reduce the processing load caused by a data transfer operation.

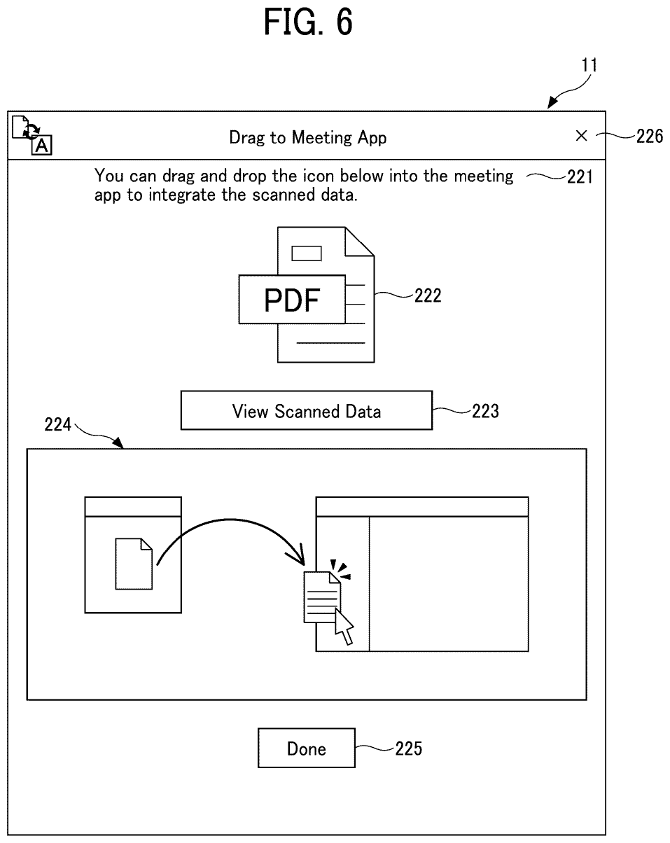

The screen control unit 26 causes the display 506 to display the integration assistance screen 11. The integration assistance screen 11 is one of the windows generated by the scanner app 13. The integration assistance screen 11 may be displayed to overlap with the screen of the scanner app 13, or may be displayed not to overlap with the screen of the scanner app 13. The details of the integration assistance screen 11 are described later with reference to FIG. 6.

The deletion unit 27 detects that the integration assistance screen 11 is closed according to a user operation, and deletes the file stored in the temporary folder. This prevents the accumulation of files in the temporary folder, thereby preventing disk space on the HD 504 from being consumed.

When the target app 12 is not running, the launch request unit 28 requests to launch the target app 12 via the OS integration unit 30. By launching the target app 12, image data can be transferred to the target app 12 according to a user operation. When the image data can be received without the target app 12 running, the launch request unit 28 may not request to launch the target app 12.

The OS integration unit 30 integrates with the OS 14. The OS integration unit 30 requests the OS 14 to perform, for example, processing on the target app 12 via the OS 14. For example, the OS integration unit 30 can acquire, from the OS 14, information on whether the target app 12 is running, information on whether the integration assistance screen 11 is currently displayed, information on the display position and size of the target app 12.

### OS

The OS 14 includes a data transfer processing unit 51 and a file information integration unit 52. The data transfer processing unit 51 performs data transfer processing according to a data transfer operation that is a user operation received by the operation reception unit 23. The data transfer processing includes displaying an icon being moved according to a user operation, identifying a file, identifying the target app 12, and identifying the content of the data transfer operation (drag and drop, copy and paste, or cut and paste).

The file information integration unit 52 transfers the image data identified by the data transfer processing unit 51 to the target app 12. Accordingly, in the present embodiment, the image data can be transferred to the target app 12 by using the functionality of the OS without using, for example, the API.

### Screens in Scanner App

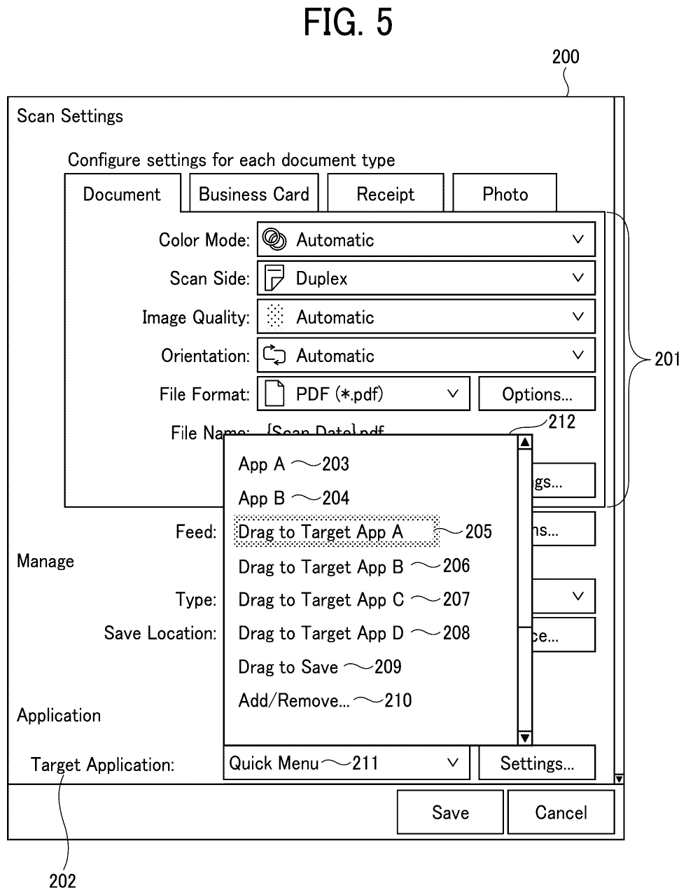

A method for setting the scanner app 13 to assist an operation of transferring data to the target app 12 is described with reference to FIG. 5. FIG. 5 is a diagram illustrating a scan settings screen 200. The scan settings screen 200 includes a reading settings section 201 and a target app setting section 202. The reading settings section 201 allows the user to specify reading conditions such as color/grayscale, reading side, image quality, document orientation, file format, and file name.

The target app setting section 202 can display a dropdown menu 212, and the dropdown menu 212 displays options for the target app 12. The options in FIG. 5 include “Drag to Target App A” 205, “Drag to Target App B” 206, “Drag to Target App C” 207, and “Drag to Target App D” 208. The options for the target app 12 are pre-set in by the user. Each of the target apps A to D has difficulty in integrating via the API due to not disclosing the API, and supports data transfer according to a data transfer operation. The number of target apps A to D (four in FIG. 5) is an example.

The options for the target app 12 such as the target apps A to D are provided because the information processing apparatus 3 launches the target app 12. That is, the target app 12 in which the user desires to use the image data obtained by scanning can automatically launch by selecting the target app 12 in advance.

Further, the dropdown menu 212 also displays options for an app that supports integration functionality via the API. The apps that support integration functionality via an API are an “App A” 203 and an “App B” 204. The options for the app are pre-set by the user. The scanner app 13 can transfer image data to the app A or B selected by the user without a data transfer operation because the apps A and B disclose the APIs.

“Drag to Save” 209 is an option to be selected when the user does not need to transfer image data to the target app 12 or the app that supports integration functionality via an API. When the “Drag to Save” 209 is selected, the scanner app 13 displays the integration assistance screen 11 after scanning, but does not perform control of the target app 12, such as launching the target app. When the target app 12 is not desired to automatically launch, the “Drag to Save” 209 can be selected not to launch the target app.

Further, an option for the target app 12 or the app that discloses the API can be added to or removed from the dropdown menu 212 according to a user operation of pressing “Add/Remove” 210. In the case of an app that discloses an API, settings for the API can also be configured according to a user operation.

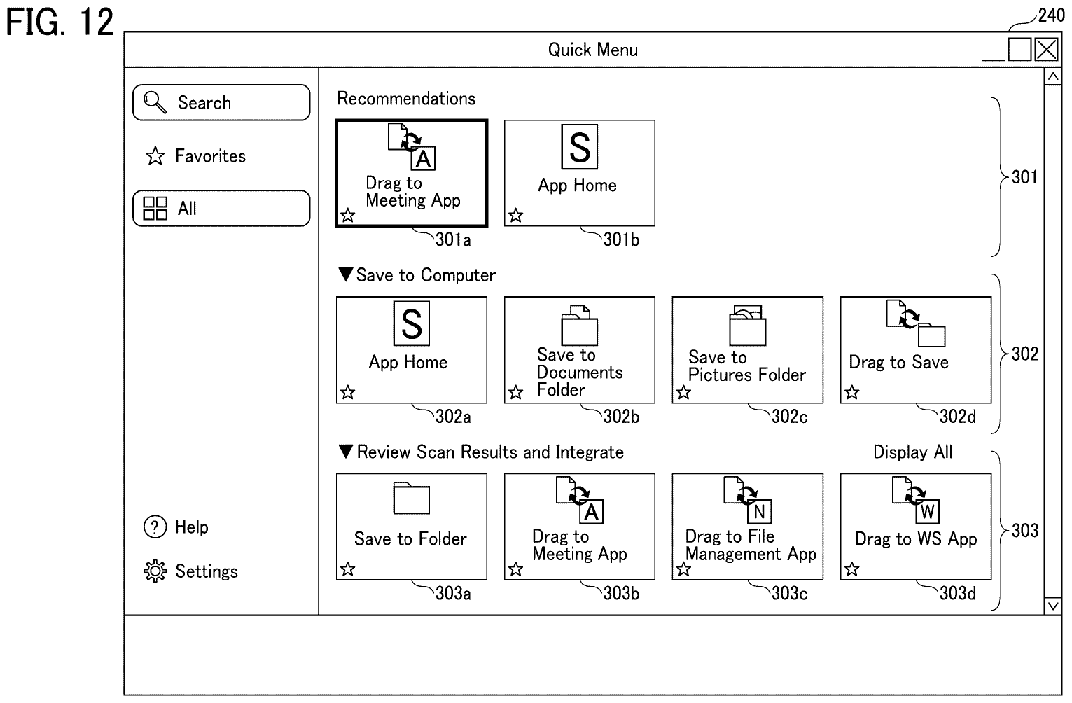

In FIG. 5, “Quick Menu” 211 is currently set to the target app setting section 202. The “Quick Menu” 211 is a setting for displaying an integration destination selection screen (see FIG. 12) after scanning, instead of setting a target app or an app that discloses an API before scanning according to a user operation. The integration destination selection screen allows the user to select a target app or an app that supports integration functionality via an API after scanning. Accordingly, when the “Quick Menu” 211 is selected, the integration destination selection screen is displayed first. As described above, in the target app setting section 202, one of the target app and the “Quick Menu” 211 can be set. When the “Quick Menu” 211 is selected instead of the target app 12, the integration destination selection screen can be displayed after scanning. Further, there is no inconsistency between the target app selected in the target app setting section 202 and the target app selected after the display of the “Quick Menu” 211 (after scanning). The details of the integration destination selection screen are provided later in a description of a second embodiment.

FIG. 6 is an example of the integration assistance screen 11. The integration assistance screen 11 is, for example, a window generated by the OS 14. The integration assistance screen 11 may be, for example, a pop-up screen displayed by the scanner app 13.

The integration assistance screen 11 includes a message 221, the file icon 222, a data display button 223, an image diagram 224, and a done button 225.

The message 221 is a sentence prompting the user to drag and drop the file icon 222. The message 221 is, for example, “You can drag and drop the icon below into the meeting app to integrate the scanned data.” The “drag and drop” may be “copy and paste” or “cut and paste,” or may be two or more of “drag and drop,” “copy and paste,” and “cut and paste.”

The file icon 222 represents a file stored in a temporary folder. The file icon 222 is displayed within a framed area. The framed area corresponds to an area defined by the screen boundary of the integration assistance screen 11.

The data display button 223 is used to display the content of a file (image data).

The image diagram 224 is an illustration for visually guiding the user how to use the integration assistance screen 11.

The done button 225 is used to close the integration assistance screen 11. The integration assistance screen 11 can be closed by pressing a cross mark 226 on the upper right.

The integration assistance screen 11 allows the user to recognize that the image data can be transferred to the target app A by dragging and dropping the file icon 222 to the target app A.

### Operation or Processes

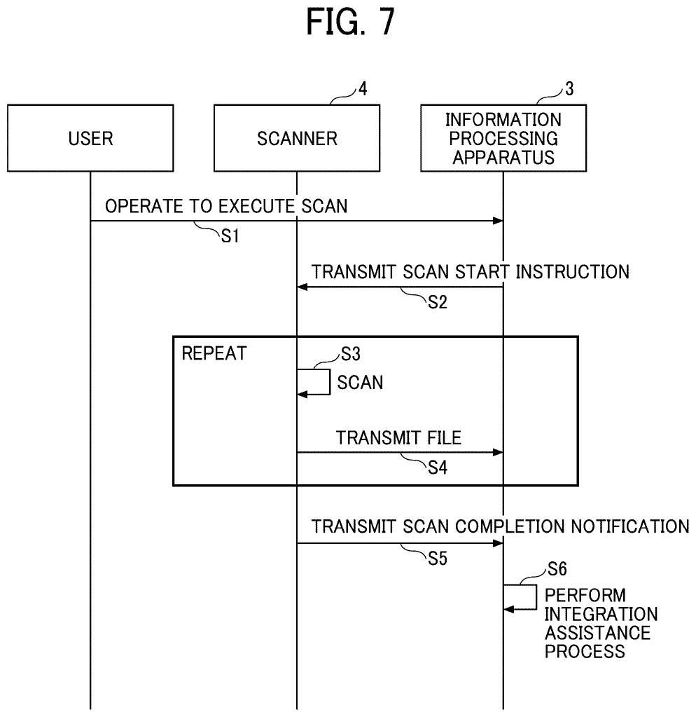

An integration assistance process flow by the scanner system 1 is described with reference to FIG. 7. FIG. 7 is a sequence diagram illustrating a process in which the scanner system 1 scans a document and the information processing apparatus 3 displays the integration assistance screen 11.

S1: The information processing apparatus 3 receives a user operation on the scanner app 13 for executing scan. The operation reception unit 23 receives the operation.

S2: The acquisition unit 21 transmits a scan start instruction to the scanner 4 in response to the operation.

S3: When the communication unit 41 of the scanner 4 receives the scan start instruction, the reading unit 42 starts scanning the document.

S4: The reading unit 42 generates a file including image data each time a page is read, and the communication unit 41 sequentially transmits the created files to the information processing apparatus 3. The file may be an image file such as a JPEG file or a PDF file. The scanner 4 may perform character recognition, and the file transmitted by the scanner 4 is not limited to image data. As described above, the scanner 4 transmits “data derived from image data” to the information processing apparatus 3.

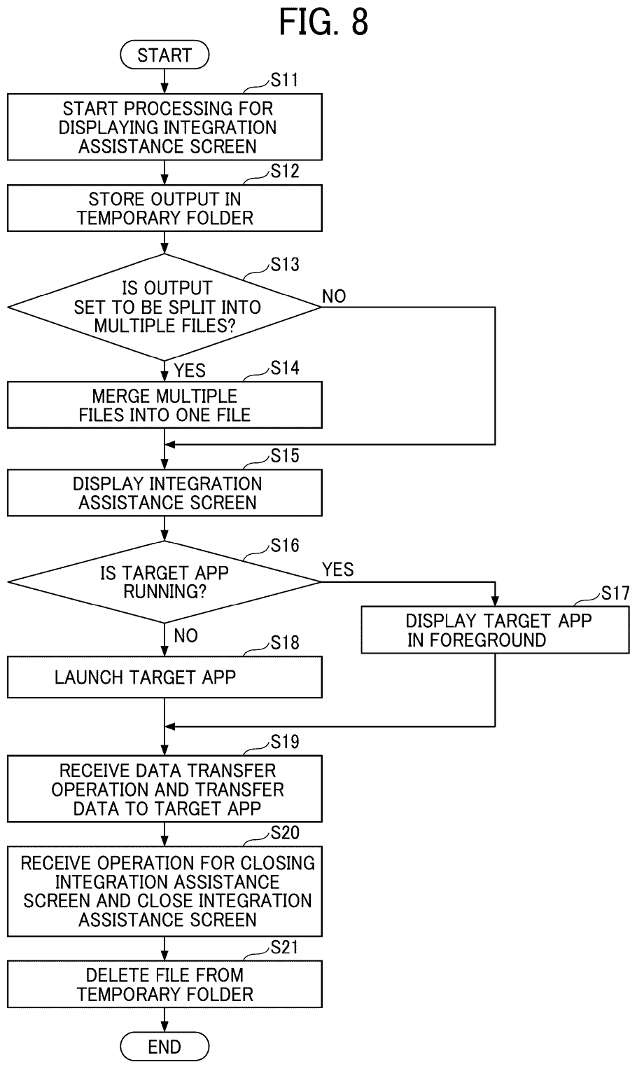

S5: When all pages of document are scanned, the reading unit 42 detects, for example, “no document” and transmits a scan completion notification to the information processing apparatus 3. In the case of reading pages one by one, the reading unit 42 transmits a scan completion notification to the information processing apparatus 3 each time when the scanning of a page is completed. S6: The acquisition unit 21 of the information processing apparatus 3 receives the scan completion notification. Accordingly, the screen control unit 26 executes an integration assistance process. The details of Step S6 are described later with reference to FIG. 8. In the present embodiment, the screen control unit 26 displays the integration assistance screen 11 after the scanner app 13 receives the scan completion notification. However, the disclosure is not limited to this. The screen control unit 26 may display the integration assistance screen 11 during the scanning. However, since a file being scanned is present in a temporary working folder, a data transfer operation is not performable by the user until the file is moved to a temporary folder prepared for the integration assistance screen 11.

The acquisition unit 21 may acquire a file including image data from a memory card connected to the information processing apparatus 3, instead of acquiring image data from the scanner 4. Further, when the information processing apparatus 3 communicates with a device storing a file, such as a smartphone or a digital camera, the acquisition unit 21 may receive the file from the smartphone or the digital camera.

The integration assistance process in Step S6 is described below with reference to FIG. 8. FIG. 8 is a flowchart of a process for displaying the integration assistance screen 11 and transferring image data to a target app according to a data transfer operation. The process is performed by the information processing apparatus 3

When the scan is started, the screen control unit 26 starts processing for displaying the integration assistance screen 11 (S11). One or more files are scanned and stored in a temporary working folder as appropriate. The temporary working folder is a folder for storing a working file for the scanner app 13.

First, the storage unit 24 stores a file (output) in a temporary folder (S12). The temporary folder is used to store a file that is displayed on the integration assistance screen 11 as the file icon 222. The file is moved from the temporary working folder to the temporary folder because the temporary working folder is for the scanner app 13 and is not preferable to be operated directly by the user. However, the file may be kept stored in the temporary working folder.

The storage unit 24 determines whether the setting is to split output into multiple files (S13). When the determination in Step S13 is Yes, the process proceeds to Step S14. When the determination is No, the process proceeds to Step S15.

In Step S14, the file merge unit 25 merges the multiple files stored in the temporary folder into one file (S14). This eliminates the need for the user to repeatedly perform the data transfer operations. Merging the multiple files into the one file is performed after the completion of the scanning of all pages.

Subsequently, the screen control unit 26 displays the integration assistance screen 11 (S15). The screen control unit 26 requests the OS 14 to display a window on which the message 221, the file icon 222, the data display button 223, the image diagram 224, and the done button 225 are arranged, via the OS integration unit 30. The screen control unit 26 can display the integration assistance screen 11 after Step S2 of FIG. 7 (however, the data transfer operation can be performed only after the files are merged into one file).

The display control unit 22 may display a preview of the content of the file before displaying the integration assistance screen 11. In this case, the screen control unit 26 may display the integration assistance screen 11 in response to a user input (for example, pressing an OK button) indicating that the preview display is viewed and confirmed. The display control unit 22 may display the preview in parallel with the integration assistance screen 11 or after displaying the integration assistance screen 11.

The launch request unit 28 determines whether the target app 12 specified by the user in the target app settings section 202 of the scan settings screen 200 is running (S16). The launch request unit 28 requests the OS integration unit 30 to inquire about whether the target app 12 is running. In response to the request from the launch request unit 28, the OS integration unit 30 transmits to the OS an inquiry to check whether the target app 12 is running, along with information for identifying the target app 12.

In the present embodiment, a data transfer operation is performed on the premise that the target app 12 is running. However, when image data can be received without the target app 12 running, the launch request unit 28 may not launch the target app 12.

When the determination in Step S16 is Yes, the process proceeds to Step S17, and when the determination is No, the process proceeds to Step S18.

In Step S17, the launch request unit 28 causes the target app 12 to be displayed in the foreground (S17). The launch request unit 28 acquires the window handle of the target app 12 and requests the OS integration unit 30 to display the target app 12 in the foreground. In response to the request from the launch request unit 28, the OS integration unit 30 passes the window handle of the target app 12 to the OS 14 and requests the OS 14 to display the target app 12 in the foreground. A window displayed in the foreground is active or currently focused and receives input operations via the keyboard or mouse.

The launch request unit 28 may highlight the target app 12 instead of or in addition to displaying the target app 12 in the foreground. For example, the launch request unit 28 requests the OS integration unit 30 to blink the window frame of the target app 12 or increase the brightness of the window frame.

In Step S18, the launch request unit 28 launches the target app 12 (S18). The launch request unit 28 requests the OS integration unit 30 to launch the target app 12. In response to the request from the launch request unit 28, the OS integration unit 30 notifies the OS 14 of information for identifying the target app 12 (the window handle of the target app 12 is not present because it has not been launched) and requests the OS 14 to launch the target app 12. The order of Step S18 and Step S15 may be reversed, or may be executed in parallel.

As described above, the integration assistance screen 11 and the screen 15 of the target app 12 are displayed on the whole screen of the information processing apparatus 3. The user drags and drops (copies and pastes or cuts and pastes) the file icon 222 displayed on the integration assistance screen 11 onto the screen 15 of the target app 12. The data transfer processing unit 51 identifies a file in the temporary folder when the operation reception unit 23 receives a click on the file icon 222. When the drag is started, the data transfer processing unit 51 causes an illustration of a file icon following the mouse cursor to be displayed. The data transfer processing unit 51 identifies the target app 12 when the operation reception unit 23 receives the drop of the file icon 222. The data transfer processing unit 51 also determines that the operation reception unit 23 has received a drag-and-drop operation.

The data transfer processing unit 51 requests the file information integration unit 52 to transfer the data by specifying the storage location of the file and the target app 12. The file information integration unit 52 transfers the file (image data) in the temporary folder to the target app 12 (S19). Transferring image data refers to notifying the target app 12 of information for identifying the file (image data) that is subject to predetermined processing performed by the target app 12.

After the data transfer operation is performed by the user, the done button 225 on the integration assistance screen 11 is pressed by the user. The operation reception unit 23 receives the pressing of the done button 225, and the screen control unit 26 closes the integration assistance screen 11 (S20).

When the screen control unit 26 closes the integration assistance screen 11, the deletion unit 27 deletes the file stored in the temporary folder (S21). The details of detecting the closing of the integration assistance screen 11 are provided later in a description of a third embodiment.

As described above, the image data can be transferred to the target app 12. The integration assistance screen 11 displaying the file icon 222 eliminates the need for the user to search for a file including image data. This can reduce operational mistakes such as file mix-ups, incorrect file transmission, or accidental deletion of a file.

Although the user presses the done button 225 at Step S20, the user may forget to press the done button 225. In this case, the deletion unit 27 does not delete the file in the temporary folder, and when the user executes the next scan, multiple files are stored in the temporary folder. In such a case, the following methods of displaying the integration assistance screen 11 are considered.

The screen control unit 26 displays the file icon 222 of a file that is obtained from the most recent scan on the integration assistance screen 11, by specifying the file from among the multiple files stored in the temporary folder by the storage unit 24 that manages the identification information (file name, file ID, time stamp, etc.) of each file. In other words, when the operation for closing the integration assistance screen 11 has not been performed from a previous operation, and a file is stored in the temporary folder together with additional data previously obtained in the previous operation, the file icon 222 representing the data that is obtained most recently is displayed.

Alternatively, the screen control unit 26 displays the file icons 222 each corresponding to one of the files stored in the temporary folder on the corresponding integration assistance screen 11. That is, the number of the integration assistance screens 11 being displayed is equal to the number of files stored in the temporary folder.

Accordingly, the screen control unit 26 displays at least the file icon 222 of the file obtained from the most recent scan on the integration assistance screen 11.

### Examples of Screens

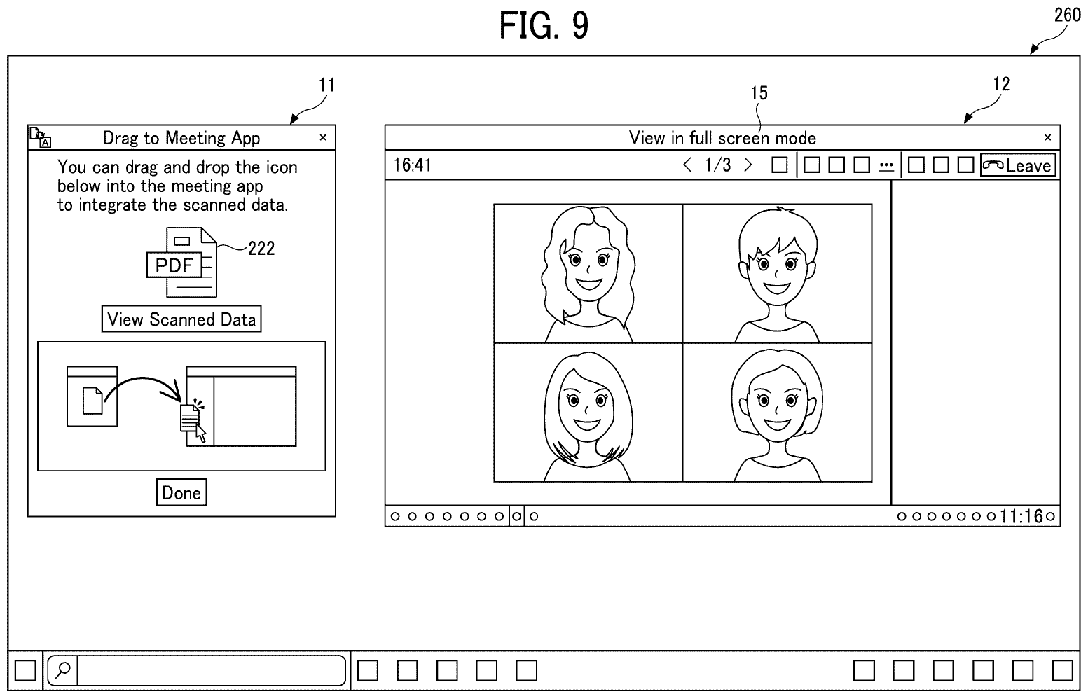

FIG. 9 is a diagram illustrating an example of a screen displayed on the information processing apparatus 3 and including the integration assistance screen 11 and the screen 15 of the target app 12. Since the target app 12 is running, the user can, for example, drag and drop the file icon 222 from the integration assistance screen 11 to the screen 15 of the target app 12.

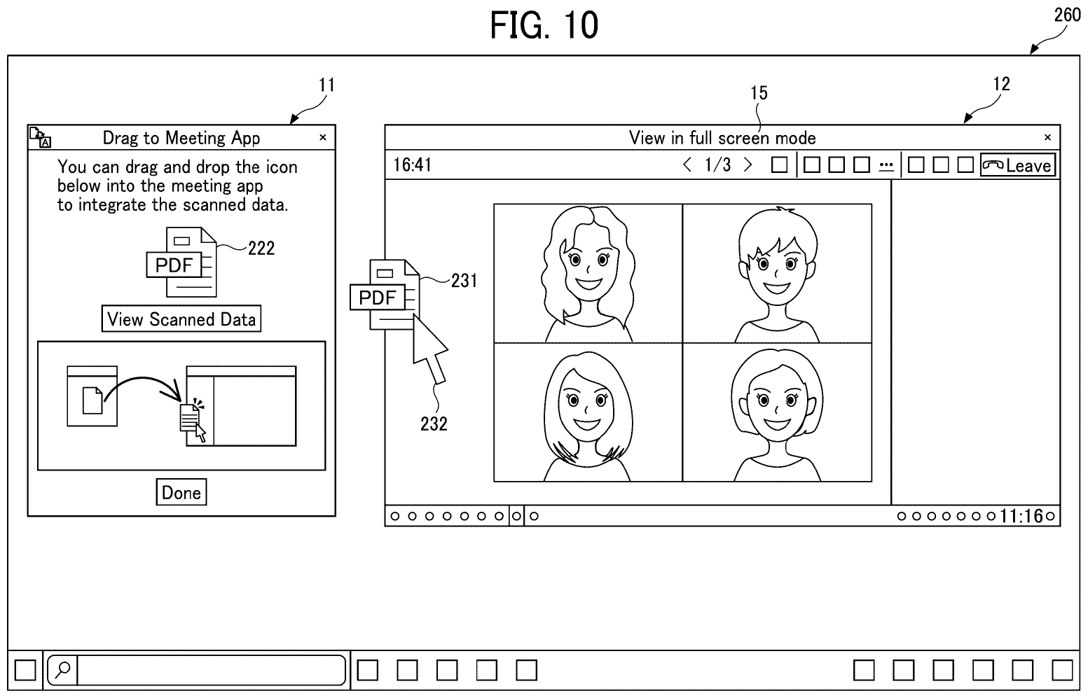

FIG. 10 is a diagram illustrating another example of a screen displayed on the information processing apparatus 3 while a drag-and-drop operation is being performed on the screen. On the screen of FIG. 10, a mouse cursor 232 and a file icon 231 being moved are displayed and represents the drag-and-drop operation. The file icon 222 on the integration assistance screen 11 does not change. This is due to the specification of the OS. When the drag-and-drop operation is started, the screen control unit 26 may display the file icon 222 on the integration assistance screen 11 in a different mode from that before the start of the drag-and-drop operation. The different mode is, for example, lowering the brightness or changing the color.

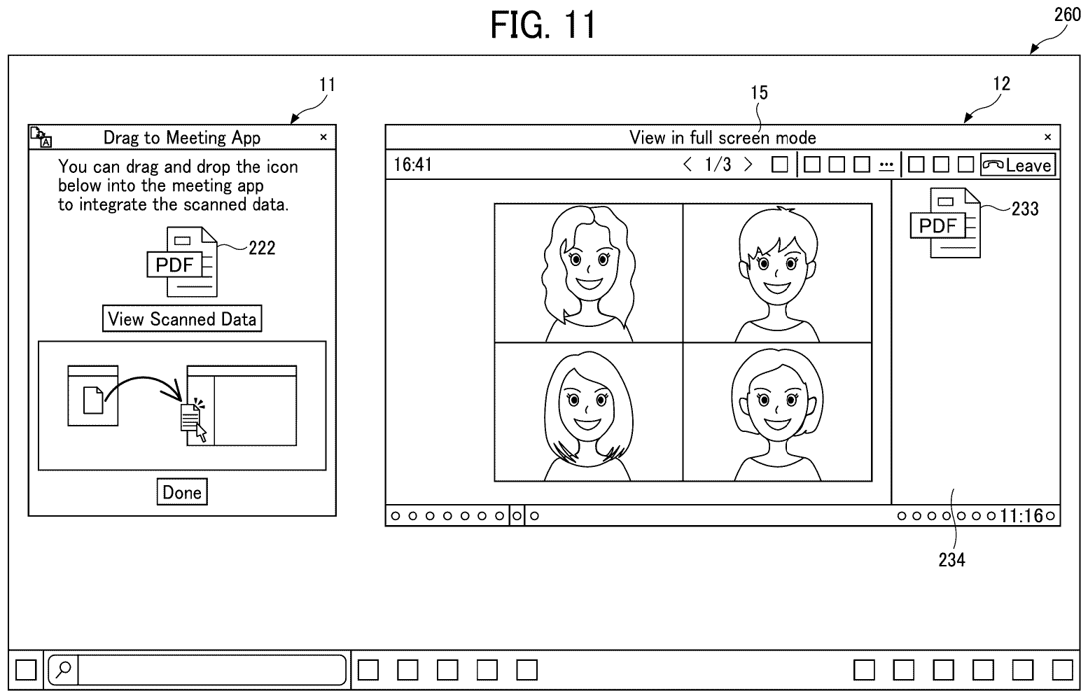

FIG. 11 is a diagram illustrating still another example of a screen displayed on the information processing apparatus 3 when a drag-and-drop operation is completed. When the target app 12 receives the image data, the file icon 233 is displayed in a chat section 234. As described above, the image data can be transferred to the target app 12 that does not support integration functionality via an API by a simple operation performed by the user. In an app such as a video conference app in which a transmission destination of a file is different for each conference, even when an API is disclosed, setting the API is not easy. The scanner app 13 of the present embodiment can also achieve substantially the same effect for an app whose API is open to the public.

The information processing apparatus 3 of the present embodiment automatically displays the integration assistance screen 11 including the file icon 222 by executing scan, and thus, the user does not need to set a folder for the scanner app 13 or open the folder. Image data can be transferred to the target app 12 by a simple operation performed by the user such as dragging and dropping the file icon 222 displayed on the integration assistance screen 11 to the target app 12 that uses the image data. Accordingly, the scanner app 13 can reduce operational mistakes such as image data mix-ups, incorrect image data transmission, or accidental deletion of image data. Further, this facilitates the resolution of issues such as difficulties in integrating data between applications.

### Second Embodiment

In the first embodiment, the target app 12 is specified by the user before the scan is executed. In the following description of a second embodiment, an explanation of a scanner app 13 is provided, and the target app 12 is specified by the user after the scan is executed.

The hardware configuration illustrated in FIG. 3 and the functional configuration illustrated in FIG. 4 of the first embodiment are applicable to the present embodiment.

Setting after Scan

A screen to receive a user operation for selecting the target app 12 after scanning is described with reference to FIG. 12. FIG. 12 is a diagram illustrating an integration destination selection screen 240 displayed by the scanner app 13. The integration destination selection screen 240 is a screen that allows the user to select the target app 12 or select a folder for storing a file after scanning.

In a “Recommendations” section 301, select buttons 301a and 301b corresponding to folders or apps that the user has used in the past or frequently uses are displayed.

In a “Save to Computer” section 302, select buttons 302b to 302d corresponding to save destination folders to be selected when a file is saved to a computer (information processing apparatus 3) are displayed. When one of the select buttons 302b to 302d is selected as the save destination folder according to a user operation, the file generated by the most recent scan is stored in the selected folder.

Further, a dedicated application select button 302a is displayed in the “Save to Computer” section 302. The dedicated application is an application for integration with the scanner app 13, and is used for displaying a file, etc. That is, when the dedicated application select button 302a is selected, the dedicated application launches (when the dedicated application is not running), and the dedicated application can display the file generated by the most recent scan.

In a “Review Scan Results and Integrate” section 303, select buttons 303b to 303d corresponding to the target apps to which image data is to be transferred after a preview is displayed are displayed. For example, when the user presses one of the select buttons 303b to 303d, the scanner app 13 displays a preview. For example, when the user closes the preview display, the integration assistance screen 11 is displayed. The scanner app 13 launches the target app 12 based on the selected one of the select buttons 303b to 303d.

Further, a select button 303a of “Save to Folder” is displayed in the “Review Scan Results and Integrate” section 303. The select button 303a of “Save to folder” is for saving a file to a folder, but not in the target app 12, after the scanner app 13 displays a preview. When the select button 303a of “Save to folder” for saving a file to a folder is selected, the image data is not transferred to the target app 12. The folder as a save destination is pre-set by the user or can be set when the select button 303a is pressed.

Further, the integration destination selection screen 240 also includes select buttons corresponding to applications that have integration functionally via an API. When one of the select buttons is selected, the scanner app 13 can call the API and transfer a file to the selected application after displaying a preview of the file obtained from the most recent scan.

### Operation or Processes

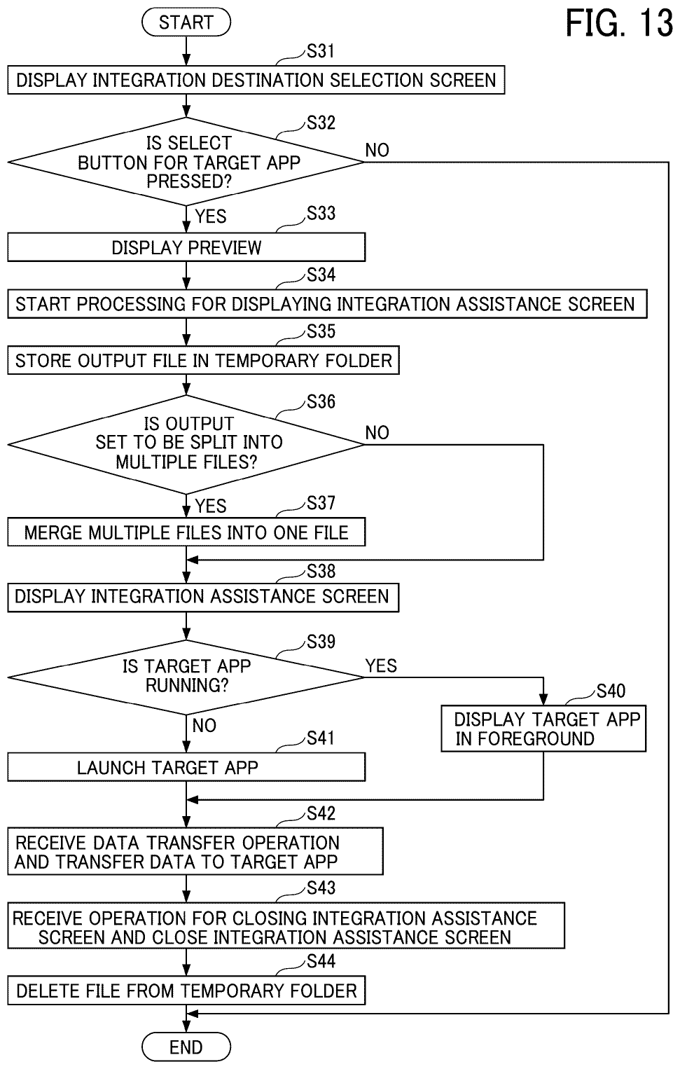

FIG. 13 is a flowchart of a process for displaying the integration assistance screen 11 after display of a preview and transferring image data to the target app 12 according to a data transfer operation. The process is performed by the information processing apparatus 3 In the description referring to FIG. 13, differences from FIG. 8 are focused. In the present embodiment, it is assumed that the “Quick Menu” 211 is set in the target app settings section 202 of the scan settings screen 200.

When the scan is started, the display control unit 22 automatically displays the integration destination selection screen 240 illustrated in FIG. 12 (S31). The integration destination selection screen 240 may be displayed according to a user operation for displaying the integration destination selection screen 240, instead of being automatically displayed. The integration destination selection screen 240 may be displayed after the completion of the scan. The integration destination selection screen 240 can be displayed after the scan is started in Step S2 of FIG. 7.

The operation reception unit 23 determines whether the select button for the target app 12 is pressed on the integration destination selection screen 240 (S32). That is, the operation reception unit 23 determines whether any of the select buttons 303b to 303d displayed in the “Review Scan Results and Integrate” section 303 is pressed.

When the determination in Step S32 is Yes, the process proceeds to Step S33, and when the determination is No, the process of FIG. 13 ends since the following operation is performed based on the button pressed by the user. When the determination in Step S32 is No and when the select button 303a is pressed, the file generated by the most recent scan is automatically stored in the folder after the preview is displayed as described above. When one of the select buttons 302a to 302d displayed in the “Save to Computer” section 302 is pressed, image data is transferred to a dedicated application without displaying a preview or is automatically stored in a folder.

In Step S33, the scanner app 13 displays a preview of the file stored in the temporary working folder (S33). The preview may be displayed after the integration assistance screen 11 is displayed. The preview may be displayed in parallel with the integration assistance screen 11.

The subsequent steps may be substantially the same as those in FIG. 8. Accordingly, the integration assistance screen 11 is displayed in response to the selection of the target app 12.

### Examples of Screens

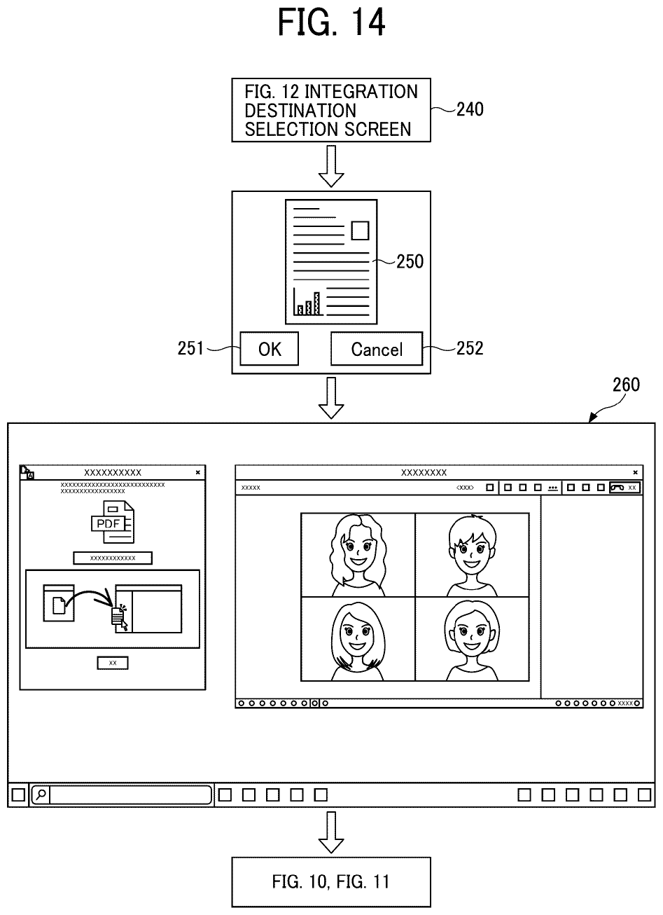

A screen transition displayed on the information processing apparatus 3 in the present embodiment is described below with reference to FIG. 14. FIG. 14 is a diagram illustrating a screen transition in displaying the integration assistance screen 11 on the information processing apparatus 3. After the scan is started, the display control unit 22 displays the integration destination selection screen 240 of FIG. 12. In the following description, it is assumed that the user presses any one of the select buttons 303b to 303d for the target app 12 that are displayed in the “Review Scan Results and Integrate” section 303.

Accordingly, the display control unit 22 displays a preview 250 of a file that is obtained from the most recent scan. The user can check the preview 250 and determine whether to transfer the file to the target app 12. When an OK button 251 is pressed, the file is transferred to the target app 12, and when a cancel button 252 is pressed, the file is not to be transferred. In the following description, it is assumed that the OK button 251 is pressed.

When the OK button 251 is pressed, the screen control unit 26 displays the integration assistance screen 11. The screen control unit 26 may display the integration assistance screen 11 before displaying the preview. When the target app 12 is not running, the launch request unit 28 launches the target app 12. Accordingly, the integration assistance screen 11 and the screen 15 of the target app 12 are displayed as illustrated in FIG. 9. After that, the screen transitions as in FIGS. 10 and 11, as in the first embodiment.

According to the present embodiment, in addition to the effects of the first embodiment, image data can be transferred to the target app 12 selected by the user after the preview of the image data is viewed and confirmed by the user.

### Third Embodiment

The details of deleting a file from a temporary folder upon detecting that the user has manually closed the integration destination selection screen 240 are provided in the following description of a third embodiment.

### Functions

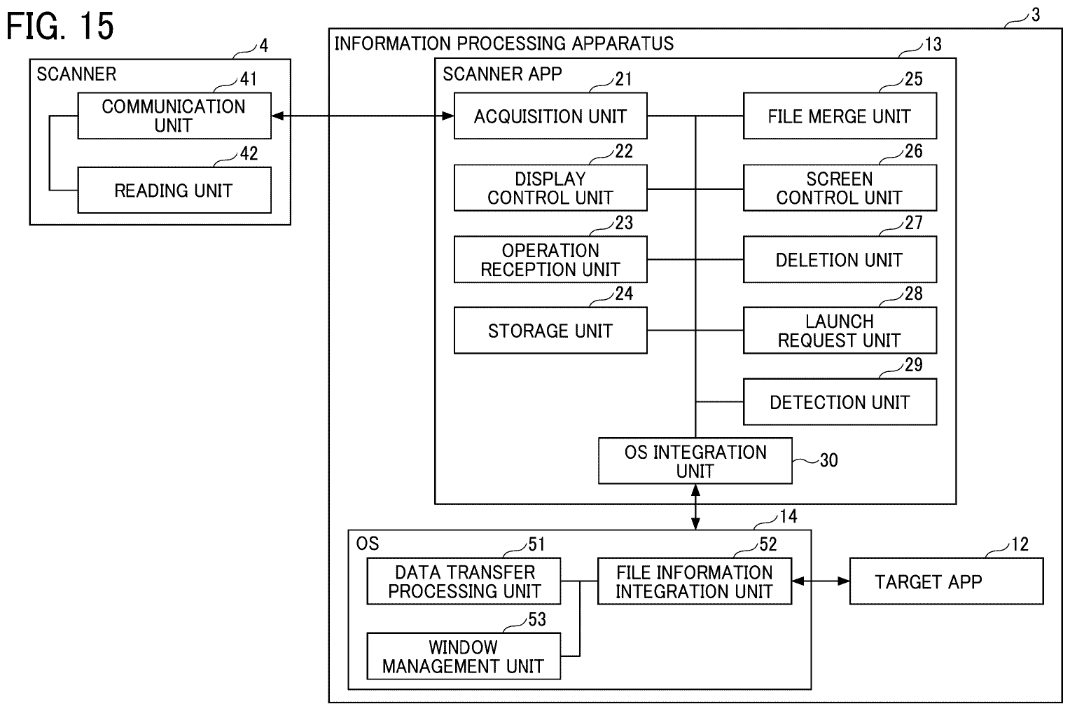

FIG. 15 is a block diagram illustrating functions of the scanner 4 and the information processing apparatus 3. The functions of a scanner may be substantially the same as those in FIG. 4.

### Information Processing Apparatus

The information processing apparatus 3 according to the third embodiment further includes a detection unit 29. The detection unit 29 detects that the integration assistance screen 11 is closed according to a user operation, via the OS integration unit 30. When the screen control unit 26 displays the integration assistance screen 11, the window handle of the integration assistance screen 11 is acquired. The detection unit 29 can acquire the state of the integration assistance screen 11 via the OS integration unit 30 by specifying the window handle.

### OS

The OS 14 according to the third embodiment further includes a window management unit 53. The window management unit 53 manages whether a window is present. Further, the window management unit 53 manages the display position of a window when the window is present.

### Operation or Processes

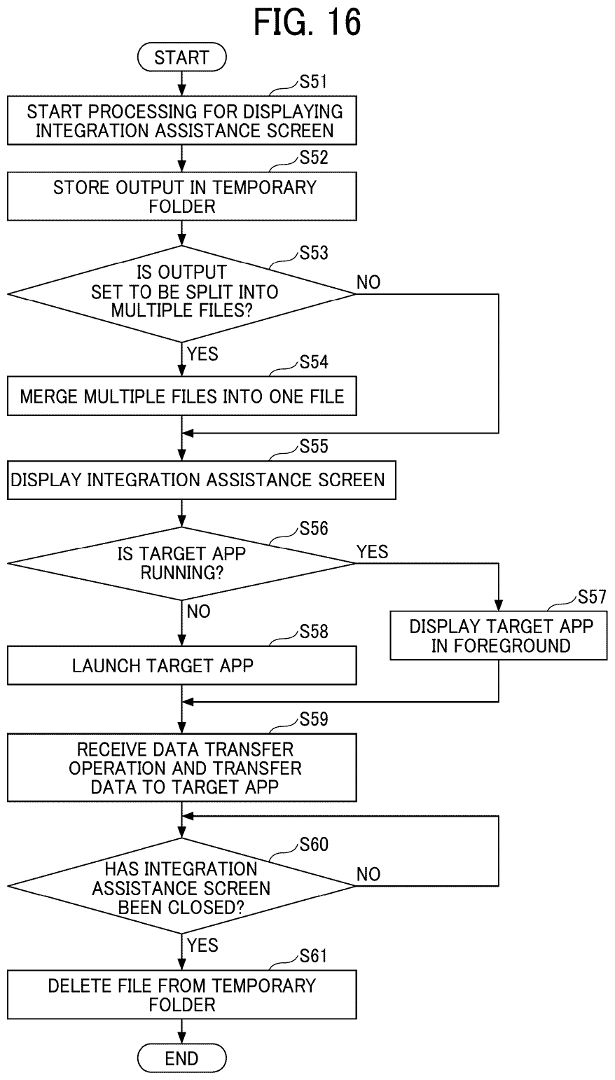

FIG. 16 is a flowchart of a process for displaying the integration assistance screen 11 and transferring image data to the target app 12 according to a data transfer operation. The process is performed by the information processing apparatus 3 In the description referring to FIG. 16, differences from FIG. 8 are focused. Steps S51 to S59 in the process may be substantially the same as Steps S11 to S19 of FIG. 8.

In Step S60, the operation reception unit 23 receives an operation for closing the integration assistance screen 11, and the detection unit 29 determines whether the integration assistance screen 11 has been closed (S60). After displaying the integration assistance screen 11, the detection unit 29 requests the OS integration unit 30 to inquire whether the integration assistance screen 11 has been closed. The OS integration unit 30 specifies the window handle of the integration assistance screen 11 and acquires the state of the integration assistance screen 11 from the OS. For example, the detection unit 29 can detect that the integration assistance screen 11 is closed from a response indicating that the integration assistance screen 11 is not open.

When the determination in Step S60 is Yes, the process proceeds to Step S61, and when the determination in Step S60 is No, the processing of Step S60 is repeated. However, when the detection unit 29 does not detect that the integration assistance screen 11 is closed even after a certain period of time has elapsed, it may be determined that the integration assistance screen 11 is not closed. In this case, the process of FIG. 16 ends while the integration assistance screen 11 is displayed.

In Step S61, since the integration assistance screen 11 is closed, the deletion unit 27 deletes the file in the temporary folder (S61).

Although a part of the process of FIG. 16 is substantially the same as that of FIG. 8 of the first embodiment, the detection unit 29 can detect that the integration assistance screen 11 is closed in FIG. 13 of the second embodiment.

According to the present embodiment, in addition to the effects of the first embodiment and the second embodiment, the file can be deleted from the temporary folder when it is detected that the integration assistance screen 11 is closed according to a user operation.

### Fourth Embodiment

In the following description of a fourth embodiment, an explanation of the scanner app 13 that automatically closes the integration assistance screen 11 when detecting the completion of data transfer to the target app 12 is provided.

### Functions

The functional configuration illustrated in FIG. 15 of the third embodiment is applicable to the present embodiment. However, the function of the detection unit 29 differs from that in the third embodiment.

### Information Processing Apparatus

The detection unit 29 of the present embodiment detects that the file information integration unit 52 has transferred image data to the target app 12 via the OS integration unit 30. Alternatively, the detection unit 29 may monitor a folder that is to receive image data for the target app 12, and detect that the folder has received the image data.

### OS

The window management unit 53 of the present embodiment detects that a file has been dragged and dropped into the window of the target app 12.

### Operation or Processes

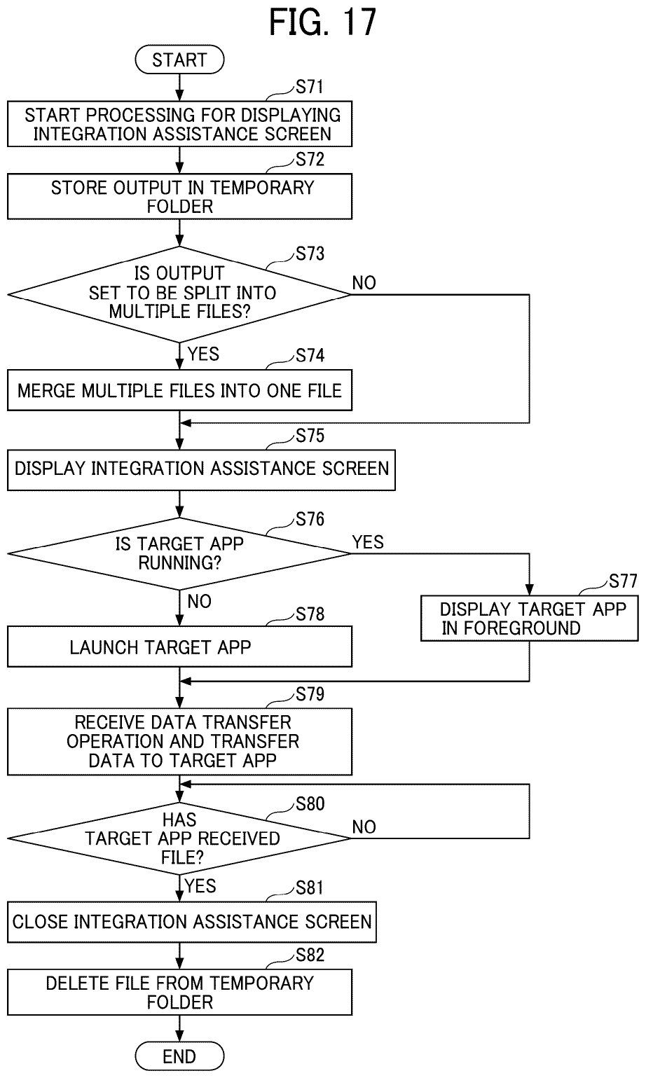

FIG. 17 is a flowchart of a process for displaying the integration assistance screen 11 and transferring image data to a target app according to a data transfer operation. The process is performed by the information processing apparatus 3 In the description referring to FIG. 17, differences from FIG. 8 are focused. Steps S71 to S79 in the process may be substantially the same as Steps S11 to S19 of FIG. 8.

In Step S80, the detection unit 29 determines whether the target app 12 has received image data (S80). Two determination methods are described below.

After displaying the integration assistance screen 11, the detection unit 29 specifies a file and requests the OS integration unit 30 to inquire whether the file information integration unit 52 has transferred the file to the target app 12. The OS integration unit 30 specifies the file and inquires of the OS 14 whether the file information integration unit 52 has transferred the image data to the target app 12. For example, the detection unit 29 can detect that the file has been transferred to the target app 12 based on a response indicating that the file information integration unit 52 has successfully transferred the data.

After the integration assistance screen 11 is displayed, the detection unit 29 monitors a folder that is to receive image data for the target app 12, and detects that the folder has received the image data. Since the file name of the image data is known, whether the file having this file name is added to the folder is determined.

When the determination in Step S80 is Yes, the process proceeds to Step S81, and when the determination in Step S80 is No, the processing of Step S80 is repeated. However, when the detection unit 29 does not detect that the target app 12 has received the image data even after a certain period of time has elapsed, it may be determined that a user operation of data transfer operation has not been performed. In this case, the process of FIG. 17 ends while the integration assistance screen 11 is displayed.

In Step S81, the screen control unit 26 closes the integration assistance screen 11 because it is detected that the target app 12 has received the image data. That is, the screen control unit 26 requests the OS 14 to close the integration assistance screen 11 via the OS integration unit 30.

Then, since the integration assistance screen 11 is closed, the deletion unit 27 deletes the file in the temporary folder (S82). The closing of the integration assistance screen 11 can be detected in substantially the same manner as in Step S60 of FIG. 16.

Although a part of the process of FIG. 17 is substantially the same as that of FIG. 8 of the first embodiment, the detection unit 29 can detect that the target app 12 has received the image data in FIG. 13 of the second embodiment.

According to the present embodiment, in addition to the effects of the first embodiment and the second embodiment, the integration assistance screen 11 can be closed, and the file in the temporary folder can be deleted when it is detected that the target app 12 has received the image data. Accordingly, even when the user forgets to close the integration assistance screen 11, the integration assistance screen 11 can be closed, and the file in the temporary folder can be deleted. This also prevents the accumulation of many files in the temporary folder, thereby preventing disk space on the HD 504 from being consumed.

### Fifth Embodiment

In the following description of a fifth embodiment, an explanation of the scanner app 13 that adjusts the display position of the integration assistance screen 11 not to overlap with the target app 12 is provided.

The functional configuration illustrated in FIG. 15 of the third embodiment is applicable to the present embodiment.

When the target app 12 is running, the integration assistance screen 11 may overlap with the screen 15 of the target app 12. When the target app 12 is not running, the screen 15 of the target app may overlap with the integration assistance screen 11 after the target app 12 launches. Although the data transfer operation is performable even when the integration assistance screen 11 and the screen 15 of the target app overlap, this make the user be confused in performing an operation. To cope with this, in the present embodiment, the scanner app 13 adjusts the display position of the integration assistance screen 11 not to overlap with the screen 15 of the target app 12.

Case where Target App has been Launched (is Running)

The screen control unit 26 acquires the display position of the target app 12 from the OS 14 via the OS integration unit 30. Since the OS 14 manages the display position of each window, the screen control unit 26 can acquire the display position of the screen 15 of the target app 12 by specifying the window handle.

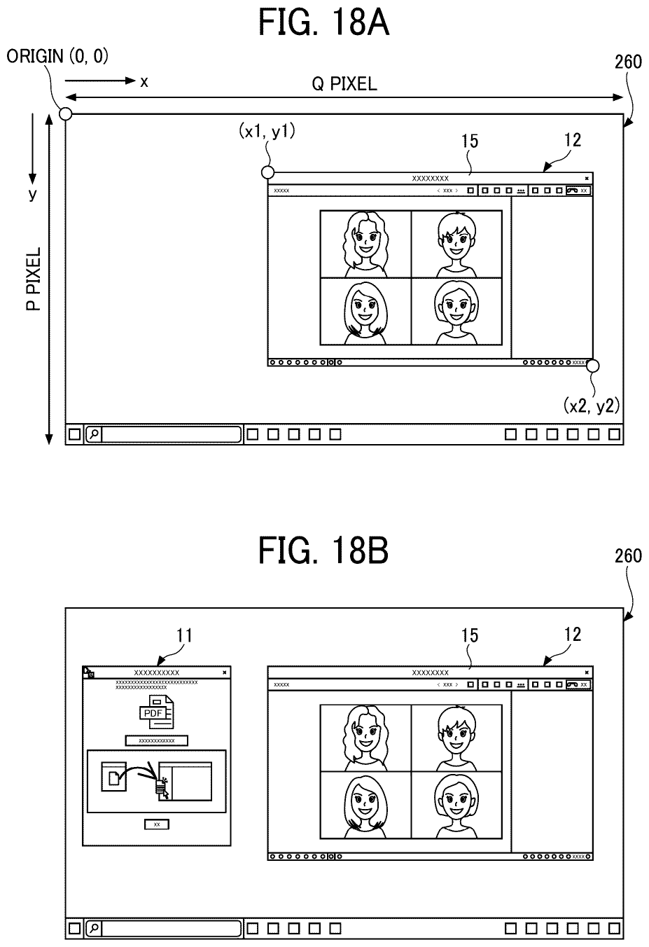

FIGS. 18A and 18B are diagrams each illustrating a display position of the screen 15 of the target app on a screen 260 (entire screen 260) of the information processing apparatus 3. The upper left corner of the entire screen 260 is set to an origin (0,0), and the coordinates of the entire screen 260 are defined by the x axis and the y axis illustrated in FIG. 18A. The screen control unit 26 may acquire the display position (x1, y1) (x2, y2) of the screen 15 of the target app 12. The screen control unit 26 can acquire the number of vertical pixels P and the number of horizontal pixels Q of the entire screen 260 from the OS 14. The screen control unit 26 determines which side, to the left or right of the target app 12, is wider based on the display position. Then, the screen control unit 26 determines to display the integration assistance screen 11 in the wider space. In FIG. 18A, there is more space to the left of the target app 12 than to the right.

Accordingly, as illustrated in FIG. 18B, the screen control unit 26 displays the integration assistance screen 11 to the left of the screen 15 of the target app 12. The screen control unit 26 determines the position of the integration assistance screen 11 so that the center of the integration assistance screen 11 is located at ½×x1 in the x direction (the midpoint of the left space). The position in the vertical direction may be, for example, the center of the entire screen 260 or the same height as the screen 15 of the target app 12.

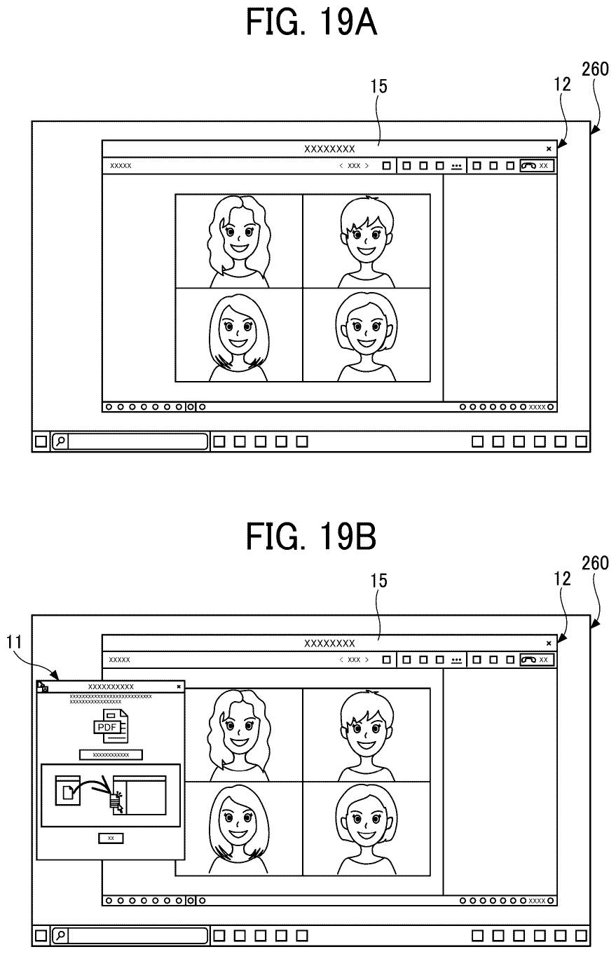

As illustrated in FIG. 19A, there may be a case where there is not enough space in the entire screen 260. FIG. 19A is a diagram illustrating the entire screen 260 of the information processing apparatus 3 on which the screen 15 of the target app 12 is displayed and there is not enough space for displaying another screen. The screen control unit 26 determines whether the wider space is equal to or greater than the threshold. The threshold may be the size of the integration assistance screen 11 in the width direction. When the wider space is equal to or greater than the threshold, the integration assistance screen 11 is displayed as illustrated in FIG. 18B.

When the wider space is less than the threshold, the screen control unit 26 displays the integration assistance screen 11 along the right or left edge of the wider space within the entire screen so that the entire integration assistance screen 11 fits within the visible area. In FIG. 19A, the space on the left to the screen 15 of the target app 12 is wider than that on the right to the screen 15.

Accordingly, as illustrated in FIG. 19B, the screen control unit 26 displays the integration assistance screen 11 along the left edge on the entire screen 260 so that the entire integration assistance screen 11 fits within the visible area. This minimizes the area where the integration assistance screen 11 and the screen 15 of the target app 12 overlap with each other. Because the overlapping area of the screen 15 of the target app 12 and the integration assistance screen 11 is minimal, the user can easily drag and drop the file icon 222.

When the screen 15 of the target app 12 is displayed in full screen, the screen control unit 26 may display the screen 15 at any position such as the center (at least the horizontal or vertical center) of the entire screen 260.

Case where Target App has not been Launched (is not Running)

When the target app 12 is not running, the launch request unit 28 launches the target app 12. Either the launch of the target app 12 or the display of the integration assistance screen 11 may be performed first. However, in a case where the launch of the target app 12 is performed first, the same process as that in a case where the target app 12 has been launched is performed. When the integration assistance screen 11 is displayed first, the screen control unit 26 determines whether the integration assistance screen 11 and the screen 15 of the target app 12 overlap with each other after the launch of the target app 12, and performs the same process as that in a case where the target app 12 has been launched when the integration assistance screen 11 and the screen 15 of the target app 12 overlap each other. When the integration assistance screen 11 is displayed first, the integration assistance screen 11 is to be moved. To eliminate an operation for moving the integration assistance screen 11, the target app 12 may be launched before the integration assistance screen 11 is displayed.

### Operation or Processes

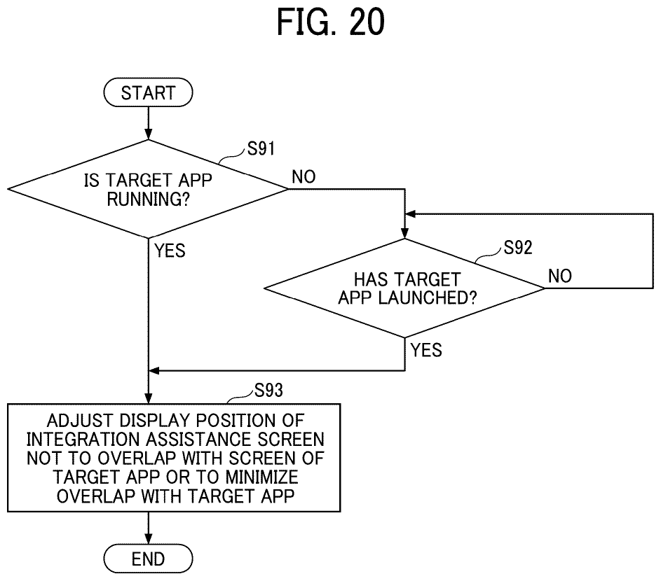

FIG. 20 is a flowchart of a process for adjusting the display position of the integration assistance screen 11 performed by the screen control unit 26. The process of FIG. 20 is performed when the screen control unit 26 displays the integration assistance screen 11 in the first to fourth embodiments.

First, the screen control unit 26 determines whether the target app 12 is running (S91). This determination method may be substantially the same as that of Step S16 of FIG. 8. When the determination in Step S91 is Yes, the process proceeds to Step S93, and when the determination is No, the process proceeds to Step S92.

In Step S92, the screen control unit 26 waits until the target app 12 launches (S92).

When the target app 12 launches (Yes in S92) or when the target app 12 has launched (Yes in S91), the screen control unit 26 adjusts the display position of the integration assistance screen 11 so that the integration assistance screen 11 does not overlap with the screen 15 of the target app 12 or the overlap is minimized (S93).

The scanner app 13 of the present embodiment adjusts the display position of the integration assistance screen 11 not to overlap with the target app 12 or adjusts the display position of the integration assistance screen 11 to minimize the overlap. This allows the user to easily perform a data transfer operation.

In the related art, transferring image data to an application requires a manual user operation, resulting in a high operational burden. That is, when a target application provides an API or a similar interface and the scanner app can call the API and integrate with the target application, the scanner app can transfer data derived from image data (referred to simply as image data) to the target application without user intervention.

In contrast, using image data in an application that does not provide any APIs or integration functionality requires the user to transfer the image data manually via the drag-and-drop function provided by the operating system (OS), following the procedure below.
1. The user sets a folder for the scanner app to store image data output by a scanner.
2. The scanner reads a document, and the scanner app stores image data in the folder specified in 1.
3. The user operates file management software provided by an OS to open the folder specified in 1.
4. The user searches the opened folder for the image data output by the scanner. 5. The user drags and drops the image data to an application.
6. The user deletes the image data that is no longer necessary from the folder.

As described above, an operation for transferring image data to an application is complicated, and such an operation can cause a mistake such as a data mix-up, incorrect image data transmission, or accidental deletion of image data.

According to one or more embodiments, a technique to reduce the operational burden caused by manual user operations when transferring data derived from image data to an application is provided.

According to one or more embodiments, the operational burden caused by manual user operations in transferring data derived from image data to an application can be reduced.

### Others

Although the example embodiments of the present disclosure are described above, the above-described embodiments are not intended to limit the scope of the present disclosure. Thus, numerous modifications and replacements of elements are possible within the scope of the above teachings.

For example, the functional configuration illustrated in FIG. 4 is divided according to main functions to facilitate understanding of processing performed by the information processing device 3. No limitation is intended by the division of processing units or by their names. The processing of the information processing device 3 may be divided into more processing units according to the details of processing. Further, a single processing unit can be further divided into multiple processing units.

Each of the functions of the described embodiments may be implemented by one or more processing circuits or circuitry. The “processing circuit or circuitry” in the present specification includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit modules designed to perform the recited functions.

Embodiments of the present disclosure can significantly enhance computer capability and functionality. This enhancement allows users to take advantage of computers that provide more efficient and robust interaction with tables. Tables are a way to store and present information on information processing apparatuses. Further, embodiments of the present disclosure can provide a better operator experience through the use of a more efficient, powerful, and robust user interface. Such a user interface provides better interaction between humans and machines.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A computer-readable, non-transitory medium storing a computer program, wherein the computer program causes an information processing apparatus including circuitry to execute a process, the process comprising:
acquiring data derived from image data, from an external apparatus external to the information processing apparatus;
displaying a display component representing the data on a display; and
receiving an operation of moving the display component to a screen to transfer the data to an application, the screen being displayed on the display by the application installed on the information processing apparatus.

2. The computer-readable, non-transitory medium of claim 1, wherein the displaying includes displaying the display component in response to the acquiring the data.

3. The computer-readable, non-transitory medium of claim 2, the process further comprising:
receiving selection of the application after requesting the external apparatus to start reading a document; and
launching the application in a case where the application is not running when the data is acquired.

4. The computer-readable, non-transitory medium of claim 1, wherein
the displaying includes displaying the display component in response to the acquiring of the data and receiving selection of the application.

5. The computer-readable, non-transitory medium of claim 4, the process further comprising
launching the application in a case where the application is not running when the data is acquired and the selection is received.

6. The computer-readable, non-transitory medium of claim 4, the process further comprising
displaying a preview of the data before or after the displaying of the display component.

7. The computer-readable, non-transitory medium of claim 3, the process further comprising
displaying the application in foreground of an entire screen displayed on the display when the application has launched.

8. The computer-readable, non-transitory medium of claim 1, wherein
the displaying includes displaying the display component within a framed area, and
the process further includes:
storing the data in a predetermined storage area; and
deleting the data from the predetermined storage area when detecting an operation for closing the framed area.

9. The computer-readable, non-transitory medium of claim 8, wherein,
when the operation for closing the framed area has not been performed from a previous operation, and the data is stored in the predetermined storage area with additional data previously obtained in the previous operation,
the displaying includes displaying the display component representing the data that is obtained most recently.

10. The computer-readable, non-transitory medium of claim 1, wherein
the displaying includes displaying the display component within a framed area, and
the process further includes:
detecting that the application receives the data; and
closing the framed area in response to the detecting.

11. The computer-readable, non-transitory medium of claim 10, the process further comprising:
storing the data in a predetermined storage area; and
deleting the data from the predetermined storage area when detecting that the application receives the data.

12. The computer-readable, non-transitory medium of claim 1, the process further comprising:
merging a plurality of data pieces into the data when acquiring the data in a form of the plurality of data pieces from the external apparatus; and
displaying the display component representing the data obtained by merging the plurality of data pieces.

13. The computer-readable, non-transitory medium of claim 1, wherein
the displaying includes displaying the display component along with a message prompting to perform a data transfer operation by moving the display component to the screen displayed by the application.

14. The computer-readable, non-transitory medium of claim 13, wherein
the operation of moving the display component to transfer the data is one of a drag-and-drop operation, a copy-and-paste operation, and a cut-and-paste operation.

15. The computer-readable, non-transitory medium of claim 1, the process further comprising:
acquiring a display position of the screen displayed by the application; and
displaying the display component at a position not to overlap the screen displayed by the application according to the display position.

16. The computer-readable, non-transitory medium of claim 4, the process further comprising receiving the selection of the application via a screen to receive the selection of the application before the acquiring of the data.

17. An information processing apparatus, comprising circuitry configured to:
acquire data derived from image data, from an external apparatus external to the information processing apparatus;
display a display component representing the data on a display; and
receive an operation of moving the display component to a screen to transfer the data to an application, the screen being displayed on the display by the application installed on the information processing apparatus.

18. An information processing method comprising:
acquiring data derived from image data, from an external apparatus external to the information processing apparatus;
displaying a display component representing the data on a display; and
receiving an operation of moving the display component to a screen to transfer the data to an application, the screen being displayed on the display by the application installed on the information processing apparatus.
